(19) United States
(12) Patent Application Publication
(10) Pub. No.: US 2009/0038656 A1
(43) Pub. Date: Feb. 12, 2009

(54) Resiliently flexible dishwasher appliance container

(75) Inventors: Ted Eric Ahrenholtz, Minnetonka, MN (US); Justin Paul Boortz, Waconia, MN (US)

Correspondence Address: SCHROEDER & SIEGFRIED, P.A., 15600 WAYZATA BOULEVARD, SUITE 200, WAYZATA, MN, 55391, US

(73) Assignee: Quadion Corporation

(21) Appl. No.: 11/890,920

(22) Filed: Aug. 8, 2007

(51) Int. Cl. B08B 3/02

(52) U.S. Cl. 134/135; 134/201

(57) ABSTRACT

A hollow integrally molded article cleansing container of monolithic one-piece construction which is formed of a soft, pliable and resilient plastic material throughout, such as silicone rubber, and is suitable for use within a dishwasher for storing and retaining one or more small articles, such as certain dental appliances or items commonly used by infants and toddlers. The outer wall of the container includes a plurality of openings to permit a flow of water within the dishwasher to pass through the container while performing the cleansing function and an elongated narrow slit that is resiliently deformable into an enlarged opening upon application of pressure adjacent its ends to facilitate the introduction and removal of the article to be cleaned into and from the container. An integral eyelet is provided for securing the container to a rack pin within the dishwasher.

### BACKGROUND OF THE INVENTION

The present invention relates generally to the field of container devices utilized in a product sanitization process. More particularly, the present invention relates to a small appliance container which is suitable for use in an automatic dishwasher so as to prevent the loss or damage of the appliance during the cleansing process for sanitization.

It is known that dishwashers provide an effective tool for sanitizing many articles other than typical kitchen items. Small articles, such as dental retainers, mouth guards, snore guards, dentures, bleach trays, as well as baby pacifiers, bottle nipples, teething rings and the like are highly susceptible to the development of potentially infectious and injurious bacteria. The high operating temperature and water pressure of an automatic dishwasher provides an attractive and effective means for sanitizing such small articles, provided they can be properly contained to prevent loss or damage during the wash cycle.

Previous attempts have been made to develop various containing devices for cleaning such small articles in a dishwasher. For instance, various basket and other containers designed to house a plurality of small articles for cleaning can be found in U.S. Pat. Nos. 4,512,489 (Green, et al.); 4,732,291 (McConnell); 5,305,876 (Brigham); and 5,840,261 (Mönch). While each of these devices have been somewhat effective, they are generally complicated multi-component constructions which are either hingedly connected or otherwise secured together to form an enclosure that is ultimately costly to produce. Moreover, such conventional containers are typically constructed of a rigid wire or plastic material which can easily damage more delicate articles that are not properly secured and become dislodged within the container during the wash cycle.

A more recent attempt at a small appliance container for use in a dishwasher can be found in U.S. Pat. No. 6,371,642 (Nelson, et al.). This device includes a mesh bag attached to a rigid closable frame structure which is designed to enclose a plurality of small articles. Here again, however, the bag incorporates a costly and complicated multi-component hinged construction for opening and securing the bag to a rack within the dishwasher. Not only are such multi-component constructions more costly to manufacture, they are more susceptible to failure and damage caused by the dishwasher operation and repeated use thereof.

Still another more recent attempt to design such a small appliance case is shown in U.S. Pat. No. 6,705,333 (Pourcho). This patent discloses a small plastic case designed for storing a dental appliance during cleaning within a dishwasher. The case is composed of upper and lower wall sections that are hingedly connected for movement between an open and closed position to allow entry of the article to be cleaned. This device suffers from the same deficiency in that it incorporates a hinged connection which has been known to deteriorate and fail through repeated use over time.

It is therefore evident from the above that there is a distinct need in the art for a small appliance case suitable for use in an automatic dishwasher which can be formed as a simple and cost efficient one-piece moldable unit, and is formed throughout of a soft, pliable, flexible yet durable material which is dishwasher safe and will prevent the potential for loss or damage of articles contained therein. It is further evident that there is a distinct need for such a container which does not rely upon multi-component or hinged construction, and is not susceptible to damage or failure caused by repeated use and exposure to the harsh elements of a dishwasher.

### BRIEF SUMMARY OF THE INVENTION

The present invention provides a container of monolithic one-piece construction which is suitable for use within a dishwasher for storing and retaining one or more small articles, such as certain dental appliances or items commonly used by infants and toddlers. The container is integrally molded as a one-piece unit from a soft, pliable, resilient plastic material, such as silicone rubber, which is dishwasher safe and highly durable for repeated use. Although there is no particular required shape of the container, in the preferred embodiment, the container includes a pair of oppositely spaced sidewalls with a connecting wall extending therebetween. Each opposing sidewall includes a plurality of openings extending through to the interior of the container to allow passage of water for cleaning of the article(s) within the container.

A portion of the connecting wall extending between the sidewalls is provided with an elongated slit which extends through to the interior of the container and facilitates the introduction and removal of articles to be cleaned. In order to open the slit to allow passage of an article, inward pressure is applied simultaneously to the connecting wall adjacent each of the opposite ends of the slit. Due to the highly flexible and pliable nature of the material from which the container is formed, such application of pressure adjacent the slit ends causes the slit-defining portions of the connecting wall to spread transversly so as to accommodate passage of the article therethrough. Similarly, upon release of such applied pressure from the container, the resiliency of the container material causes self-closure of the slit opening.

In order to secure the container within the dishwasher and properly position it for maximum flow of water therethrough, the container includes an integrally molded retaining eyelet, the opening in which is conveniently sized to easily slide onto one of the many positioning tines or pins of any standard dishwasher rack. Preferably, the opening in the eyelet has a diameter which approximates or is slightly less than the diameter of the pin to which it is secured so that the eyelet will frictionally engage the pin and prevent dislodgement therefrom.

With use of such a soft, pliable plastic material, the ease of use and durability of the container is significantly enhanced. There are no multiple parts or frangible hinged joints in the product. Opening the container is as simple as applying light pressure adjacent the ends of the slit, and the resiliency of the material causes self-closure of the container upon release of such pressure. For more personalized use, individualized containers may be color coded for each member of a family.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a perspective view of an appliance container constructed in accordance with the present invention;

FIG. 2 is a top plan view of the container shown in FIG. 1, showing the arrangement of the sidewall perforations therein;

FIG. 3 is front elevational view of the container shown in FIG. 1, showing the formation of a slit utilized for the introduction and removal of articles to and from the container;

FIG. 4 is a vertical cross-sectional view of the container shown in FIG. 2, taken along line 4-4 thereof;

FIG. 5 is a rear elevational view of the container shown in FIG. 1, showing the optional inclusion of instructional indicia thereon; and

FIG. 6 is a perspective view of the container shown in FIG. 1 being compressed along each of its sides to cause the front slit therein to open and facilitate the introduction and removal of articles to and from the container.

### DETAILED DESCRIPTION OF THE INVENTION

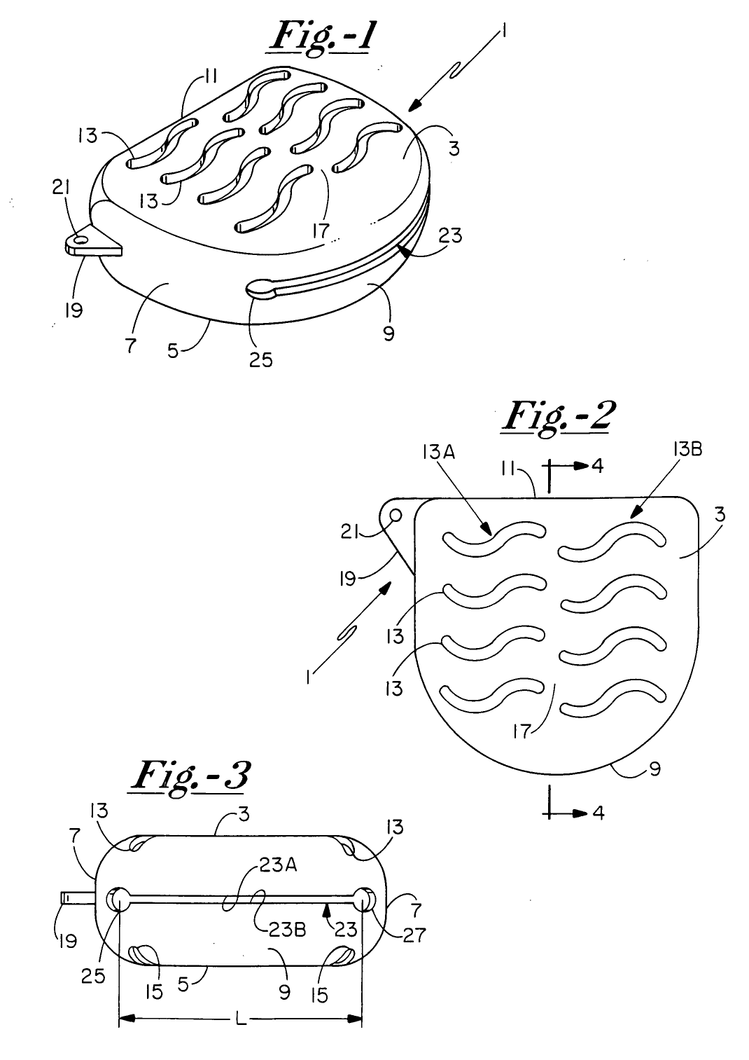

Referring to FIG. 1, a small appliance container 1 constructed in accordance with the present invention is disclosed. In general, container 1 is a monolithically constructed, one-piece storage case that is suitable for storing small articles for cleaning within a dishwasher (not shown). Container 1 is preferably integrally molded as a one-piece unit from a soft, pliable and resilient plastic material, such as silicone rubber, which is dishwasher safe and highly durable for repeated use. It is contemplated that any number of small dental appliances or items commonly used by infants and toddlers, which are generally susceptible to the development of potentially infectious and injurious bacteria, may be stored within container 1 for cleaning in a dishwasher.

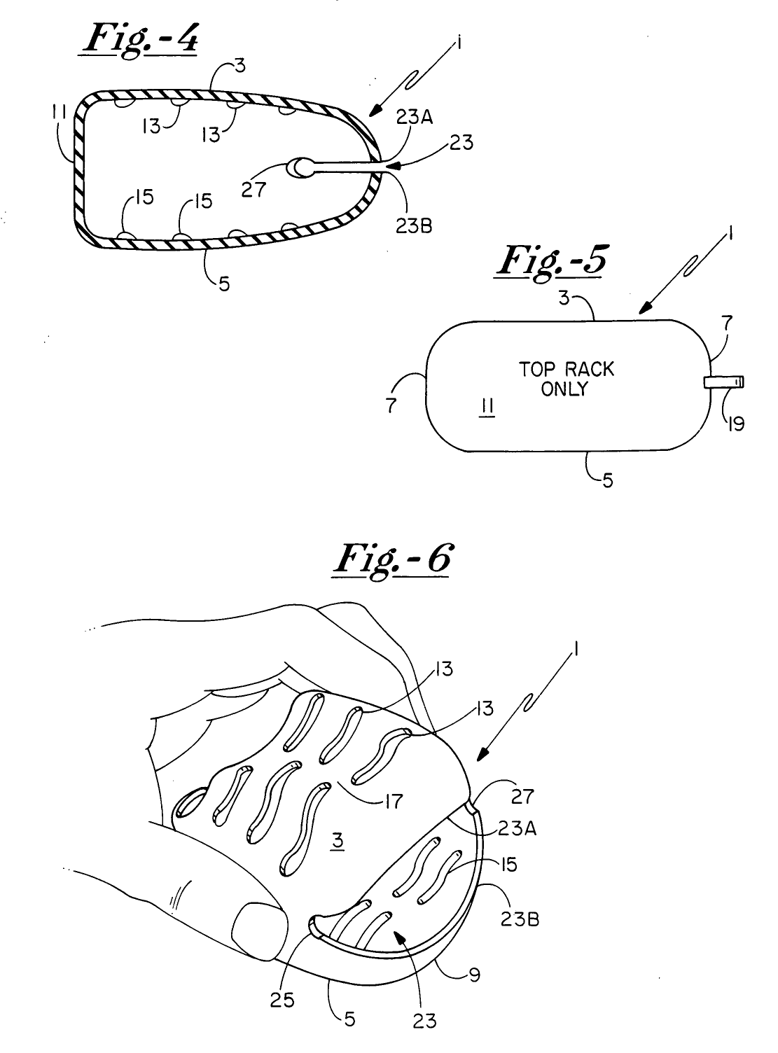

While there is no particular shape or size required for container 1, in the embodiment shown, container 1 has a generally clamshell configuration, defined by a pair of oppositely spaced sidewalls 3 and 5 with a connecting wall 7 extending therebetween. The connecting wall 7 extends around and forms the perimeter of container 1 between sidewalls 3 and 5, and includes a front wall portion 9 and a rear wall portion 11. As shown in FIG. 2, the front wall portion 9 of container 1 forms a continuous curved periphery about the front end of the container. As best shown in FIG. 4, the front wall portion 9 also forms an outwardly protruding arc extending between opposite sidewalls 3 and 5. The rear wall portion 11 of container 1, however, is more flat, thus providing a surface as shown in FIG. 5 for the inclusion of optional embossed lettering, instructional indicia and the like (i.e., “TOP RACK ONLY”). As can be seen throughout the drawings, all corners and edges between the sidewalls 3 and 5, and the connecting wall 7 are also radius to form a smooth, supple container that is devoid of any sharp protruding objects.

In the illustrated embodiment, container 1 is also shown as being of relatively small compass in relation to most conventional dishwasher baskets. As shown, container 1 is contemplated as having major dimensions from front to rear of approximately 2.75 inches; from sided to side of about 3.0 inches; and a height between sidewalls 2 and 5 of about 1.5 inches. While the thickness of the material may vary depending on the material hardness value utilized, in the preferred embodiment, it is contemplated that the container walls be about 0.08-0.10 inches thick for optimal structural integrity and operation. Although container 1 can be larger or smaller without departing from the invention herein, maintaining container 1 of somewhat smaller compass is believed to have the advantage of allowing for more personalized use of the container, as well as avoiding the possibility of commingled articles becoming damaged during a wash cycle.

Each opposing sidewall 3 and 5 includes a plurality of spaced openings 13 and 15, respectively, which allow passage of water for cleaning of the article(s) within the container during a wash cycle. As shown best in FIG. 2, openings 13 in sidewall 3 are comprised of a plurality of elongated perforations which extend through to the interior of the container 1. Although no particular shape or arrangement of openings are necessary, the elongated openings 13 in sidewall 3 are arranged as a pair of side-by-side columns of generally S-shaped openings, designated as columns 13A and 13B. Arranging openings 13 as such functions to create a central buttress or rib 17 of continuous material extending from front to back in sidewall 3, which provides further support and added structural integrity to sidewall 3. Since the openings 15 in sidewall 5 are arranged identical to and simply the mirror image of openings 13 in sidewall 3, the above discussion applies equally thereto, and therefore will not be repeated.

In order to secure the container 1 within a dishwasher and properly position it for maximum flow of water therethrough, the container 1 includes an integrally molded retaining eyelet 19, the opening 21 in which is conveniently sized to easily slide onto one of the many positioning tines or pins of any standard dishwasher rack (not shown). As shown best in FIGS. 1 and 2, eyelet 19 extends from connecting wall 7 in a plane generally parallel to sidewalls 3 and 5, with the axis of opening 21 extending generally perpendicular thereto. Such arrangement of the eyelet 19 is designed to position the container 1 within the dishwasher such that the flow of pressurized water within the dishwasher will be directed through the elongated perforations 13 and 15 in the sidewalls 3 and 5 of the container 1, thereby effectively cleaning the article(s) contained therein. As shown in the drawings, the eyelet 19 is positioned at a corner adjacent the rear wall portion 11 of the container 1, but such placement is not critical to the operation of the invention, so long as the orientation thereof facilitates the flow of water through the sidewall perforations 13 and 15. Preferably, the opening 21 in eyelet 19 has a diameter which approximates or is slightly less than the diameter of the pin to which it is secured so that the eyelet 19 will frictionally engage the pin and prevent dislodgement therefrom.

With particular reference to FIGS. 1, 3 and 4, it can be seen that a portion of the connecting wall 7 extending between the sidewalls 3 and 5 is provided with an elongated slit 23. In the embodiment shown, slit 23 extends through the front wall portion 9 of the connecting wall 7 to the interior of the container 1, and facilitates the introduction and removal of articles to be cleaned. As shown, slit 23 in free form is defined by elongated opening-defining portions 23A and 23B which extend across the front wall portion 9 approximately one-third (⅓) the distance around the container 1. In the embodiment of FIG. 3, slit 23 is shown as having a length L of approximately 2.35 inches between opposite ends 25 and 27 thereof, and a general transverse dimension between opening-defining portions 23A and 23B of approximately 0.08 inches. As shown, slit 23 extends in a plane that is generally perpendicular to the axes of perforations 13 and 15 in sidewalls 3 and 5. Each end 25 and 27 of slit 23 is slightly expanded or bulbous-shaped to further facilitate the opening of slit 23 and accommodate the passage of articles therethrough.

With particular reference to FIG. 6, it is seen that in order to open the slit 23 to allow passage of an article, inward pressure is applied simultaneously to the connecting wall 7 adjacent each of the opposite ends 25 and 27 of the slit 23. Due to the highly flexible and pliable nature of the material from which the container 1 is formed, such application of pressure adjacent the slit ends 25 and 27 causes the opening-defining portions 23A and 23B in the connecting wall 7 to readily deform and spread transversely, as shown in FIG. 6. Notably, upon compressing container 1 in such manner, the central rib 17 in sidewall 3 and the corresponding central rib in sidewall 5 also help facilitate wider opening of the slit 23 by restricting separation of the perforations 13 and 15 in sidewalls 3 and 5 adjacent the center of slit 23. This effectively pushes the central portion of opening-defining portions 23A and 23B of slit 23 further apart, thereby providing an enlarged opening to accommodate passage of an article to be cleaned therethrough. Upon release of such applied pressure from the container 1, the resiliency of the container material causes self-closure of slit 23, and the return of container 1 to its free form shown in FIG. 1.

As noted above, in a preferred embodiment of the invention, the use of silicone rubber as the container material is contemplated because it is extremely flexible, pliable and resilient which, as is evident from the above, is highly beneficial to the intended operation of the present invention. Moreover, silicone rubber is also known for its superior durability at extreme temperatures, such as for use in a dishwasher, and is a readily moldable plastic material. It has been found that the use of silicone rubber having Durometer hardness value falling within the approximate range of 10 to 90 duro Shore A is acceptable for use in the present invention, but in a preferred embodiment, the hardness value of the silicone rubber for optimal conditions falls more preferably in the range of 65 to 75 duro Shore A.

Although the use of silicone rubber is deemed preferable, it will be understood that the use of other materials is also conceivable, provided such materials are flexible, pliable and sufficiently resilient to facilitate performance of the present invention for its intended purpose. For instance, it is contemplated that other thermoset rubber materials, such as ethylene propylene diene monomer (EPDM), Nitrile, etc., having an approximate Durometer hardness value range from 10 to 90 duro Shore A would also be suitable for use in the present invention. Also, thermoplastic elastomer (TPE) materials from 30 duro Shore A to 40 duro Shore D, or thermoplastic urethane (TPU) materials from 50 duro Shore A to 80 duro Shore D may be capable of providing the flexibility and resiliency to adequately function with the present invention.

With the use of such a soft, pliable and resilient plastic material, the ease of use and durability of the container is significantly enhanced. There are no multiple parts or frangible hinged joints in the product. Opening the container is as simple as applying light pressure adjacent the ends 25 and 27 of the slit 23, and the resiliency of the material causes self-closure of the container 1 upon release of such pressure. For more personalized use, it is contemplated that individualized containers may be color coded for each member of a family.

It will, of course, be understood that various changes may be made in the form, details, arrangement and proportions of the parts without departing from the scope of the invention which comprises the matter shown and described herein and set forth in the appended claims.

1. An article cleansing container for use in a machine dishwasher, comprising:
(a) a hollow container having an integrally molded outer wall structure of monolithic construction which is formed of a pliable, resilient material throughout;
(b) said outer wall of said container having a plurality of perforations therein positioned and adapted to permit the flow of water therethrough upon operation of the dishwasher;
(c) said outer wall of said container including opening-defining portions extending through to the interior of the container which define in free form a narrow elongated slit with opposite ends, said opening-defining portions of said outer wall being resiliently deformable to facilitate the introduction and removal of the article to be cleaned into and from said container through said slit.

2. The container defined in claim 1, wherein said opening-defining portions of said outer wall are resiliently deformable upon application of inward pressure to said container adjacent said ends of said slit.

3. The container defined in claim 1, wherein the resiliency of said pliable container material facilitates opening and closing of said container upon the application and release of pressure to said container adjacent said ends of said slit.

4. The container defined in claim 1, wherein said material from which said container is constructed is composed of silicone rubber.

5. The container defined in claim 4, wherein said silicone rubber material has Durometer hardness value in the approximate range of 10 to 90 duro Shore A.

6. The container defined in claim 1, wherein said perforations in said outer wall of said container are elongated and narrow.

7. The container defined in claim 1, including an eyelet integrally formed with said outer wall for mounting and supporting said container within the dishwasher.

8. The container defined in claim 1, wherein said container is constructed such that pressure applied inward on said outer wall of said container adjacent said slit ends will cause said opening-defining portions of said outer wall to deform laterally, thereby defining an enlarged opening to the interior of said container.

9. The container defined in claim 1, wherein the length of said slit extends approximately one-third the distance around said container.

10. The container defined in claim 1, wherein the length of said slit extends less than one-half the distance around said container.

11. The container defined in claim 1, wherein said opening-defining portions of said outer wall in free form extend in a plane that is generally perpendicular to the axis of a majority of said perforations extending through said outer wall.

12. The container defined in claim 1, wherein said opening-defining portions of said outer wall extend generally parallel in free form and are readily deformable laterally relative to the length of said slit upon application of inward pressure to said container adjacent said ends of said slit.

13. An article cleansing container for use in a machine dishwasher, comprising:
(a) a hollow container being of integrally molded monolithic construction throughout, and made of a soft, pliable and resilient plastic material;
(b) said hollow container having a pair of spaced opposite sidewalls, each of said sidewalls having a plurality of perforations therein;
(c) a connector wall extending between and connecting said opposite sidewalls; and
(d) said connector wall having opening-defining portions which define a narrow elongated slit extending through said connector wall, said slit having opposite ends and said opening-defining portions of said connector wall being resiliently deformable upon application of pressure to said container adjacent said slit ends to facilitate the introduction and removal of the article into and from said container.

14. The container defined in claim 13, including a mounting member connected to said container for mounting said container within such a dishwasher so as to cause a stream of cleansing water to pass through said perforated sidewalls.

15. The container defined in claim 13, wherein said perforations in said sidewalls are elongated, narrow and curvilinear in shape.

16. The container defined in claim 13, wherein said container is constructed such that pressure applied inward on said container adjacent said slit ends will cause said opening-defining portions of said connector wall to deform laterally, thereby defining an enlarged opening to the interior of said container.

17. The container defined in claim 13, wherein the length of said slit extends approximately one-third the distance around said container.

18. The container defined in claim 13, wherein the length of said slit extends less than one-half the distance around said container.

19. The container defined in claim 13, wherein said opening-defining portions of said connector wall in free form extend in a plane that is generally parallel with at least one of said sidewalls.

20. The container defined in claim 13, wherein the axis of said slit extending through said connector wall is generally perpendicular to the axes of the majority of said perforations extending through said opposite sidewalls.

21. The container defined in claim 13, wherein said opening-defining portions of said connector wall extend generally parallel in free form and are readily deformable laterally relative to the length of said slit upon application of inward pressure to said container adjacent said ends of said slit.

22. The container defined in claim 13, wherein said plastic material is composed of silicone rubber having a Durometer hardness value in the approximate range of 10 to 90 duro Shore A.

23. An article cleansing container for use within a machine dishwasher, comprising:
(a) a hollow container being of integrally molded monolithic construction and made of a resilient silicone rubber material throughout; said container having a rear wall;
(b) a front wall positioned opposite said rear wall, said front wall having an elongated slit forming an opening therein, at least a portion of said slit extending through said front wall and being resiliently deformable intermediate its ends to facilitate the introduction and removal of the article to be cleaned while held within said container; and
(c) a pair of spaced, opposed sidewalls extending between said front and rear walls, each of said sidewalls having a plurality of spaced elongated openings extending therethrough to permit a flow of water within the dishwasher to pass through said container while performing the cleansing function.

24. The container defined in claim 23, wherein said silicone rubber material has Durometer hardness value in the range of 65 to 75 duro Shore A.

25. The container defined in claim 23, wherein the length of said slit extends less than one-half the distance around said container.

26. The container defined in claim 23, and an eyelet carried by said container and designed to support said container upon a dishwasher rack pin in position to bring the flow of a stream of cleansing water of the dishwasher into said openings of said sidewalls.

27. The container defined in claim 23, wherein said opening of said slit in said front wall is substantially enlarged and deformed by applying pressure inwardly upon said container adjacent each of said ends of said slit toward each other, to thereby facilitate the introduction of the articles into, or removal from, the interior of said container.
